(19) United States
(12) Patent Application Publication
(10) Pub. No.: US 2023/0157215 A1
(43) Pub. Date: May 25, 2023

(54) LED LIGHTING DEVICE FOR STRAWBERRY SEEDLING RAISING

(71) Applicant: SEMI CO., LTD., Jeonju-si Jeollabuk-do (KR)

(72) Inventors: Hyo LEE, Jeonju-si Jeollabuk-do (KR); Young Choul PARK, Iksan-si Jeollabuk-do (KR); Noh Joon PARK, Jeonju-si Jeollabuk-do (KR); Kang Hwa LEE, Jeonju-si Jeollabuk-do (KR); Seung Wook JUNG, Buan-gun Jeollabuk-do (KR)

(73) Assignee: SEMI CO., LTD., Jeonju-si Jeollabuk-do (KR)

(21) Appl. No.: 16/977,484

(22) PCT Filed: Jul. 28, 2020
(86) PCT No.: PCT/KR2020/009910

§ 371 Date: Sep. 2, 2020

(30) Foreign Application Priority Data
Jul. 31, 2019 (KR) 10-2019-0092869

(51) Int. Cl. A01G 7/04; A01G 22/05; A01G 7/06; A01G 9/24

(52) U.S. Cl. CPC A01G 7/045; A01G 22/05; A01G 7/06; A01G 9/249

(57) ABSTRACT

The present disclosure relates to an LED lighting device for strawberry seedling raising.

The LED lighting device for strawberry seedling raising according to an exemplary embodiment of the present disclosure includes: a light emitting unit composed of a first light emitting part composed of a red region wavelength emission LED and a blue region wavelength emission LED and a second light emitting part composed of the red region wavelength emission LED and an infrared region wavelength emission LED; and a control part for controlling the light emitting unit to manage a strawberry seedling raising, and controlling each LED included in the first light emitting part or the second light emitting part to be turned on/off based on a preset seedling raising mode.

### TECHNICAL FIELD

The present disclosure relates to an LED lighting device for strawberry seedling raising, and specifically, to an LED lighting device for strawberry seedling raising, which may drive proper LEDs for each seedling raising stage using the LED emitting a blue wavelength, a red wavelength, and an infrared wavelength to increase the early yield of strawberries.

### BACKGROUND ART

Recently, several cultivation studies have led to a rapid spread of strawberry cultivation area and an increase in production.

Strawberries propagate in the form of vegetative reproduction through stems which are grown in a manner which roots and survives the stems contacting the ground while the stems are stretched out, not germination through seeds. That is, since strawberries are vegetative propagation crops through a runner, considerable time and effort are put into seedling raising as well as field management, and raising high-quality seedling is essentially required in order to promote the cultivation of strawberries.

The seedling raising refers to the overall work of growing a high-quality seedling which has been raised for a predetermined period of time in a method such as sowing with seeds or nutrients and is best suitable for planting or the seedling grown through such work.

The biggest goal of the strawberry seedling raising is to generate as many runners as possible in a short time to pick them at the desired time and secure a lot of good seedlings.

Particularly, for successful strawberry farming, the seedling raising management and the pest control in summer are of the utmost importance. In the seedling raising management, the more runners of mother plants, the more daughter seedlings may be generated, thereby having high productivity. In addition, generally, the more nitrogen fertilizer in a range in which there occurs no obstacle and the more moisture and light quantity, the more runners are generated, and as the temperature rises, the occurrence of the runner increases, but the growth stops when the temperature is too high.

As an example of the related art related to strawberry seedling raising, there is “METHOD FOR TREATING STRAWBERRY GROWTH REGULATOR FOR SEEDLING RAISING” disclosed in Korean Patent Application Laid-Open No. 10-2018-0128372.

The related art is configure so that the growth regulator containing benzylaminopurine (6-BAP), which is a synthetic cytokinin, is treated by foliar spraying on the strawberry seedling raising, thereby effectively increasing the production of the strawberry runners to increase the number of daughter seedlings of strawberry and thus increase the production of strawberries.

However, the related art may solve a problem in that the price of the natural cytokinin is expensive, but overlooks the impact that the synthetic cytokinin may have on other parts of the plant, and there is a problem in that an environmental pollution problem may be caused due to excessive use of the growth regulator.

In addition, in order to appropriately use the growth regulator, it is necessary to closely monitor the growth state of the plant and spray an appropriate amount of the growth regulator, so that there is a problem in that a lot of labor is required.

### DISCLOSURE

### Technical Problem

The present disclosure is intended to solve such conventional problems, and an object of the present disclosure is to provide an LED lighting device for strawberry seedling raising, which may drive proper LEDs for each seedling stage using the LED emitting a blue wavelength, a red wavelength, and an infrared wavelength to increase the early yield of strawberries even without a growth regulator.

### Technical Solution

An LED lighting device for strawberry seedling raising according to one aspect of an exemplary embodiment of the present disclosure includes: a light emitting unit including a first light emitting part including a red region wavelength emission LED and a blue region wavelength emission LED and a second light emitting part including the red region wavelength emission LED and an infrared region wavelength emission LED; and a control part for controlling the light emitting unit to manage a strawberry seedling raising, and controlling each LED included in the first light emitting part or the second light emitting part to be turned on/off based on a preset seedling raising mode.

In addition, the preset seedling raising mode may be performed by any one of a runner increase mode which increases runners of mother plants or a flower bud differentiation mode which induces a flower bud differentiation of daughter seedlings, all LEDs of the first light emitting part and the second light emitting part may be controlled to be turned on/off simultaneously in the runner increase mode, and all LEDs of the second light emitting part may be controlled to be turned on/off simultaneously in the flower bud differentiation mode.

In addition, the LEDs of the first light emitting part and the LEDs of the second light emitting part may be controlled independently of each other, and controlled according to a state image and the number of runners of the strawberry seedling raising.

In addition, the first light emitting part or the second light emitting part may be controlled in a pulse width modulation (PWM) method.

In addition, the first light emitting part and the second light emitting part may share the red region wavelength emission LED, in the runner increase mode which increases the runners of the mother plants, an output of the first light emitting part may be formed larger than an output of the second light emitting part, and the red region wavelength emission LED shared by the first light emitting part and the second light emitting part may be controlled by the output of the first light emitting part, and the output of the second light emitting part in the flower bud differentiation mode which induces the flower bud differentiation of the daughter seedlings may be formed larger than the output of the second light emitting part in the runner increase mode.

In addition, in the flower bud differentiation mode, (1) the output of the first light emitting part and the output of the second light emitting part may be formed to be the same as each other, or (2) the output of the first light emitting part may be formed smaller than the output of the second light emitting part, and if the output of the first light emitting part is formed smaller than the output of the second light emitting part, the red region wavelength emission LED shared by the first light emitting part and the second light emitting part may be controlled by the output of the first light emitting part.

In addition, the light emitting unit may include: two or more first light emitting parts, and the red region wavelength emission LED and the blue region wavelength emission LED of each of the first light emitting parts may be formed by applying each of different amounts of red fluorescent substances to a single blue region wavelength emission LED.

In addition, an amount of the red fluorescent substance applied to any one of the plurality of blue region wavelength emission LEDs of the first light emitting part may be different from an amount of the red fluorescent substance applied to another blue region wavelength emission LED, and an amount of the red fluorescent substance applied to any one of the plurality of red region wavelength emission LEDs of the first light emitting part may be different from an amount of the red fluorescent substance applied to another red region wavelength emission LED.

In addition, the light emitting unit may include: two or more second light emitting parts, the red region wavelength emission LEDs included in the second light emitting parts may be formed independently of the red region wavelength emission LED comprised in the first light emitting part, an amount of the red fluorescent substance applied to any one of the plurality of blue region wavelength emission LEDs of the first light emitting part may be the same as an amount of the red fluorescent substance applied to another blue region wavelength emission LED, and an amount of the red fluorescent substance applied to any one of the plurality of red region wavelength emission LEDs of the first light emitting part may be the same as an amount of the red fluorescent substance applied to another red region wavelength emission LED.

In addition, the LED lighting device for strawberry seedling raising may further include: a camera module for photographing the state of the strawberry seedling raising to collect an image, in which the control part may control the first light emitting part or the second light emitting part based on the state image of the strawberry seedling raising collected by the camera module.

In addition, the LED lighting device for strawberry seedling raising may further include: a wavelength detection sensor for detecting a wavelength of the light emitted from the light emitting unit, in which the control part may correct the state image of the seedling raising collected by the camera module according to the wavelength of the light detected by the wavelength detection sensor.

In addition, the LED lighting device for strawberry seedling raising may further include: a temperature sensor for measuring a temperature of a strawberry seedling raising cultivation space, in which the control part may control the first light emitting part or the second light emitting part based on the temperature measured by the temperature sensor.

In addition, in the flower bud differentiation mode which induces the flower bud differentiation of the daughter seedlings, (1) if the temperature of the strawberry seedling raising cultivation space falls within a range of 10 degrees Celsius to 25 degrees Celsius, the control part may operate only the second light emitting part to suppress an increase in the temperature, and (2) if the temperature of the strawberry seedling raising cultivation space is less than 10 degrees Celsius, the control part may operate the first light emitting part and the second light emitting part to increase the temperature, and operation times of the first light emitting part and the second light emitting part in the flower bud differentiation mode may be equal to or less than 12 hours per day.

In addition, the LED lighting device for strawberry seedling raising may further include: a condensing lens for reaching the light emitted from the first light emitting part and the second light emitting part only within a strawberry seedling raising cultivation range on the end of the emission side of the light emitting unit.

In addition, the condensing lens may be formed in a shape corresponding to the form of a strawberry seedling raising bed in which the strawberry seedling raising is performed.

A strawberry seedling raising method according to another aspect of the exemplary embodiment of the present disclosure includes: in the strawberry seedling raising method using an LED lighting device for strawberry seedling raising including: a light emitting unit including a first light emitting part including a red region wavelength emission LED and a blue region wavelength emission LED and a second light emitting part including the red region wavelength emission LED and an infrared region wavelength emission LED; and a control part for controlling the light emitting unit to manage a strawberry seedling raising, and controlling each LED included in the first light emitting part or the second light emitting part to be turned on/off based on a preset seedling raising mode, determining a strawberry seedling raising mode which determines, as the preset seedling raising mode, any one of a runner increase mode which increases runners of mother plants and a flower bud differentiation mode which induces a flower bud differentiation of daughter seedlings; and controlling the light emitting unit which controls at least one of the first light emitting part and the second light emitting part according to the determined strawberry seedling raising mode.

In addition, all LEDs of the first light emitting part and the second light emitting part may be controlled to be turned on/off simultaneously in the runner increase mode, and all LEDs of the second light emitting part may be controlled to be turned on/off simultaneously in the flower bud differentiation mode.

In addition, the first light emitting part and the second light emitting part may share the red region wavelength emission LED, in the runner increase mode, an output of the first light emitting part may be formed larger than an output of the second light emitting part, and the red region wavelength emission LED shared by the first light emitting part and the second light emitting part may be controlled by the output of the first light emitting part, the output of the second light emitting part in the flower bud differentiation mode may be formed larger than the output of the second light emitting part in the runner increase mode, in the flower bud differentiation mode, (1) the output of the first light emitting part and the output of the second light emitting part may be formed to be the same as each other, or (2) the output of the first light emitting part may be formed smaller than the output of the second light emitting part, and if the output of the first light emitting part is formed smaller than the output of the second light emitting part, the red region wavelength emission LED shared by the first light emitting part and the second light emitting part may be controlled by the output of the first light emitting part.

In addition, the LED lighting device for strawberry seedling raising may include: a camera module for photographing a state of the strawberry seedling raising to collect an image; and the LED lighting device for strawberry seedling raising may further include: a wavelength detection sensor for detecting a wavelength of the light emitted from the light emitting unit, in which the control part may correct a state image of the seedling raising collected by the camera module according to the wavelength of the light detected by the wavelength detection sensor, and the control part may control the first light emitting part or the second light emitting part based on the corrected state image of the strawberry seedling raising collected by the camera module.

In addition, the LED lighting device for strawberry seedling raising may further include: a temperature sensor for measuring the temperature of a strawberry raising seedling cultivation space, in which the control part may control the first light emitting part or the second light emitting part based on the temperature measured by the temperature sensor, in the flower bud differentiation mode which induces the flower bud differentiation of the daughter seedlings, (1) if the temperature of the strawberry seedling raising cultivation space falls within a range of 10 degrees Celsius to 25 degrees Celsius, the control part may operate only the second light emitting part to suppress an increase in the temperature, and (2) if the temperature of the strawberry seedling raising cultivation space is less than 10 degrees Celsius, the control part may operate the first light emitting part and the second light emitting part to increase the temperature, and operation times of the first light emitting part and the second light emitting part in the flower bud differentiation mode may be equal to or less than 12 hours per day.

### Advantageous Effects

The present disclosure may secure the number of daughter seedlings by generating the stable runner in the seedling raising stage, and promote the uniform appearance of first flower cluster through the induction of appropriate flower bud differentiation, thereby increasing the early yield.

In addition, the present disclosure may secure the excellent daughter seedlings in the small area to maximize the effect after planting the daughter seedlings in the field, and obtain both the effects of maximizing growth and preventing disease and insect pest.

### DESCRIPTION OF DRAWINGS

FIG. 1 is a schematic diagram illustrating an LED lighting device for strawberry seedling raising according to an exemplary embodiment of the present disclosure.

FIG. 2 is a diagram illustrating a configuration of the LED lighting device for strawberry seedling raising according to the exemplary embodiment of the present disclosure.

FIG. 3 is a schematic diagram for explaining a strawberry seedling raising method using the LED lighting device for strawberry seedling raising according to the exemplary embodiment of the present disclosure.

FIG. 4 is a schematic diagram illustrating a PWM control of a first light emitting part and a second light emitting part according to the exemplary embodiment of the present disclosure.

FIG. 5 is a schematic diagram of a light emitting unit according to another exemplary embodiment of the present disclosure.

FIG. 6 is a schematic diagram illustrating an LED lighting device for strawberry seedling raising according to another exemplary embodiment of the present disclosure.

FIG. 7 is a flowchart illustrating the strawberry seedling raising method using the LED lighting device for strawberry seedling raising according to the exemplary embodiment of the present disclosure.

### BEST MODE

Hereinafter, exemplary embodiments of the present disclosure will be described in detail with reference to the accompanying drawings. However, in describing the present disclosure, if the detailed description of the known configuration obscures or does not clarify the technical spirit of the present disclosure, the description of the known configuration will be omitted.

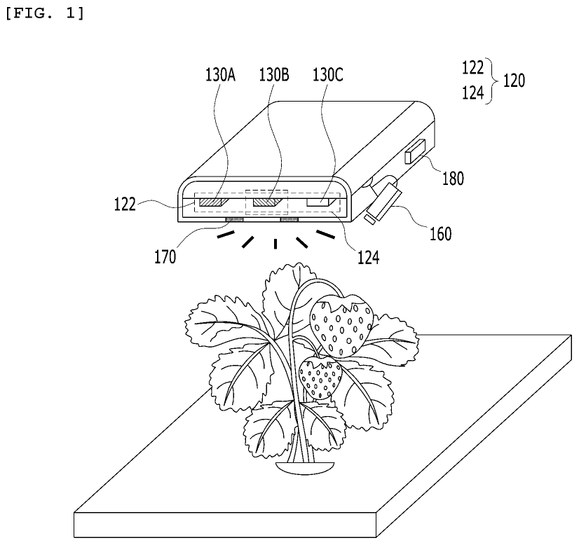

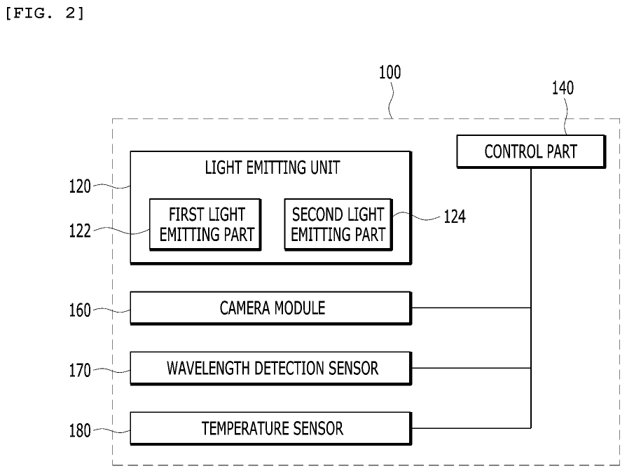

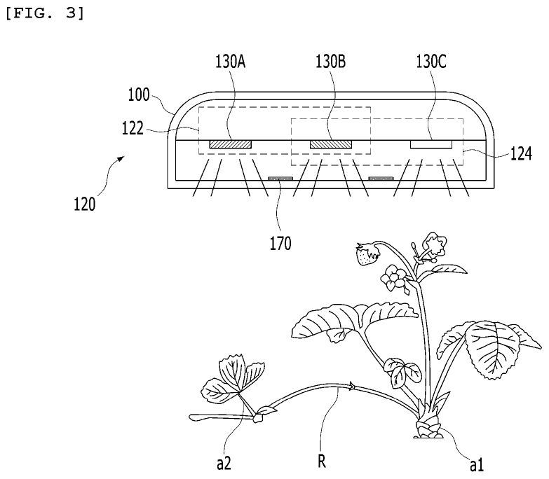

FIG. 1 is a schematic diagram illustrating an LED lighting device for strawberry seedling raising according to an exemplary embodiment of the present disclosure, FIG. 2 is a diagram illustrating a configuration of the LED lighting device for strawberry seedling raising according to the exemplary embodiment of the present disclosure, and FIG. 3 is a schematic diagram for explaining a strawberry seedling raising method using the LED lighting device for strawberry seedling raising according to the exemplary embodiment of the present disclosure.

As illustrated in FIGS. 1 and 2, an LED lighting device 100 for strawberry seedling raising according to an exemplary embodiment of the present disclosure includes a light emitting unit 120 and a control part 140, and has the light emitting unit 120 and the control part 140 configured in a form mounted on a circuit board, which are disposed inside a casing.

The light emitting unit 120 includes a first light emitting part 122 composed of a red region wavelength emission LED 130B and a blue region wavelength emission LED 130A, and a second light emitting part 124 composed of the red region wavelength emission LED 130B and an infrared region wavelength emission LED 130C.

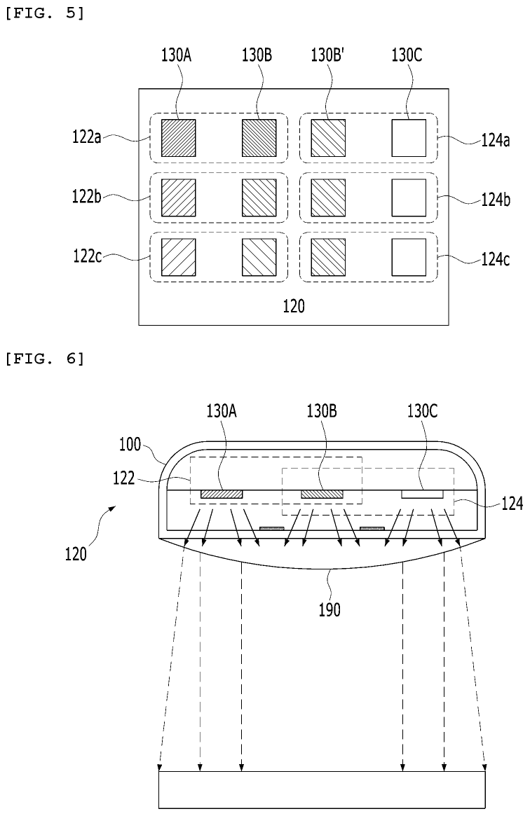

In FIG. 1, FIG. 3, and FIG. 6 to be described later, although it is illustrated that one red region wavelength emission LED 130B is simultaneously included in the first light emitting part 122 and the second light emitting part 124, a configuration in which different red region wavelength emission LEDs 130B are included in each of the first light emitting part 122 and the second light emitting part 124 is also possible (see FIG. 5). That is, the first light emitting part 122 and the second light emitting part 124 share the red region wavelength emission LED 130B.

The control part 140 controls the light emitting unit 120 to manage strawberry seedling raising, and controls each of the LEDs included in the first light emitting part 122 or the second light emitting part 124 to be turned on/off based on a preset seedling raising mode.

The control part 140 is configured to perform a control function of the light emitting unit 120, a control function of a camera module and each sensor to be described later, and an analysis function of the collected image, and may be configured to include a storage space for storing the collected image and a general strawberry seedling raising image.

In the LED lighting device 100 for strawberry seedling raising according to the exemplary embodiment of the present disclosure, the preset seedling raising mode is composed of any one of a runner increase mode which increases runners R of mother plants a1 or a flower bud differentiation mode which induces flower bud differentiation of daughter seedlings a2.

The most important process in the strawberry seedling raising process may be divided into a process of increasing the number of runners generated in the mother plants and a process of inducing the flower bud differentiation, thereby advancing a flowering time.

The ‘runner’ refers to the long stem from the main stem of the mother plants (mother seedlings), and it is very important to stably generate the runner during the strawberry cultivation process because the number of daughter seedlings may be determined by the number of runners.

The ‘flower bud differentiation’ means that a growing point changes into a flower bud, and that the growing point continuously differentiating into leaves stops differentiating into leaves and differentiates into flowers.

The flower bud is required to be first made in order to form the strawberries, and under natural conditions, the flower bud differentiation begins in mid-September in the northern hemisphere.

The strawberries have the property in which when a first flower differentiates, other flowers including a second flower in the same flower cluster continuously differentiate, so that in the case of promoting the flower bud differentiation, the sequential flowering including the differentiation of the first flower early occurs.

The seedling raising mode allows the LED to emit (irradiate) in different methods according to different situations requiring light (lighting) in the strawberry seedling raising process so that rapid growth and flowering may be implemented, and each LED emits the light in different methods in the runner increase mode or the flower bud differentiation mode.

As an example, in the runner increase mode, all LEDs of the first light emitting part 122 and the second light emitting part 124 are controlled to be turned on/off simultaneously.

The inventor of the present disclosure confirmed that the number of runners generated of the strawberry seedling raising could be increased if the red region wavelength emission LED 130B and the blue region wavelength emission LED 130A included in the first light emitting part 122 and the red region wavelength emission LED 130B and the infrared region wavelength emission LED 130C included in the second light emitting part 124 were simultaneously combined and used through an on/off control of the first light emitting part 122 and the second light emitting part 124 for the runner of the strawberry seedling raising. If the runner increase mode is selected based on such a result, all LEDs of the first light emitting part 122 and the second light emitting part 124 are configured to be on/off controlled simultaneously.

However, the outputs of each LED included in the first light emitting part 122 and each LED included in the second light emitting part 124 are not necessarily controlled to be the same as each other, that is, each LED included in the first light emitting part 122 and each LED included in the second light emitting part 124 are controlled independently of each other, and the output of the LED of each of the first light emitting part 122 and the second light emitting part 124 is preferably controlled appropriately according to the state (image) of the strawberry seedling raising and the number of runners.

As another example, in the flower bud differentiation mode, all LEDs of the second light emitting part 124 are controlled to be turned on/off simultaneously.

When the flower bud differentiation is completed through the image analysis of the flower bud to be described later, planting is performed at a place for seedling raising to promote the development of the flower bud, and as the planting is faster, the development of the flower bud is promoted, thereby advancing a harvest time.

The applicant of the present disclosure experimented the flower bud differentiation according to the individual driving of each LED or the driving of the first and/or second light emitting parts using the LED lighting device 100 for strawberry seedling raising according to the present exemplary embodiment, and confirmed that a flower bud differentiation induction rate was highest if the red region wavelength emission LED 130B and the infrared region wavelength emission LED 130C included in the second light emitting part 124 were simultaneously driven. If the flower bud differentiation mode is selected based on such a result, all LEDs of the second light emitting part 124 are configured to be on/off controlled simultaneously.

However, similar to the aforementioned runner increase mode, the output of each LED included in the second light emitting part 124 in the flower bud differentiation mode is not necessarily controlled to be the same as each other, and the output of each LED is preferably controlled appropriately according to the flower bud differentiation state.

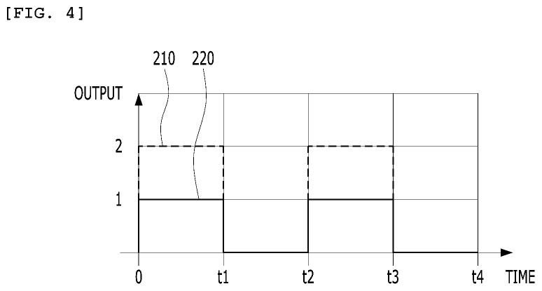

FIG. 4 is a schematic diagram illustrating a PWM control for a first light emitting part and a second light emitting part according to the exemplary embodiment of the present disclosure.

The first light emitting part 122 or the second light emitting part 124 according to the exemplary embodiment of the present disclosure is controlled in a pulse width modulation (PWM) method.

The pulse width modulation (PWM) control adjusts the width of the pulse to adjust the size and time of the power transferred to each LED, thereby facilitating the on/off of the light emitting unit 120.

By using the PWM control in the LED lighting device 100 for strawberry seedling raising according to the present exemplary embodiment, each LED, more preferably, the first light emitting part 122 and the second light emitting part 124 are controlled to be automatically turned on/off by programming even without a strawberry seedling raising manager controlling the LED lighting device 100 to be manually turned on/off.

As an example, FIG. 4 illustrates a PWM control line diagram 210 of the first light emitting part 122 and a PWM control line diagram 220 of the second light emitting part 124 in the runner increase mode. In the runner increase mode according to the present exemplary embodiment, the control part 140 may control each LED included in the first light emitting part 122 to have a (relative) output with the size of 2 units, and control each LED included in the second light emitting part 124 to have a (relative) output with the size of 1 unit in the PWM method, and be configured to control all LEDs included in the first light emitting part 122 and the second light emitting part 124 to be turned on/off simultaneously. That is, in the runner increase mode, the output of the blue region wavelength emission LED 130A may be formed more strongly. As an example, if the first light emitting part 122 is controlled to have the output with the size of 2 units and the second light emitting part 124 is controlled to have the output with the size of 1 unit, the red region wavelength emission LED 130B simultaneously included in the first light emitting part 122 and the second light emitting part 124 may be controlled to have the output with the size of 2 units. If the first light emitting part 122 and the second light emitting part 124 include the red region wavelength emission LEDs 130B independently of each other, the red region wavelength emission LED 130B may be operated according to the control output of the first light emitting part 122 and the second light emitting part 124.

The size of the unit is only exemplary, and a configuration in which the output of the LED included in the first light emitting part 122 or the second light emitting part 124 has multiple of a decimal number such as 2.5 units is also possible.

Meanwhile, in the flower bud differentiation mode, both the first light emitting part 122 and the second light emitting part 124 may be operated at the same output level. Meanwhile, in the present exemplary embodiment, although it has been described that both the first light emitting part 122 and the second light emitting part 124 are turned on in the flower bud differentiation mode, the outputs of the red region wavelength emission LED 130B and the infrared region wavelength emission LED 130C, and the blue region wavelength emission LED 130A may be reduced or the output of the blue region wavelength emission LED 130A may be controlled in an off state.

The inventor of the present disclosure proposed a configuration of providing light in different wavelength bands in the case of different seedling raising modes, considering that if the runner needs to be increased, the light in the blue region and red region wavelengths is effective, and if the flower bud needs to be differentiated, the light in the red region wavelength and the light in the infrared wavelength region are effective.

In the light emitting unit 120 according to the exemplary embodiment of the present disclosure, each of the red region wavelength emission LED, the blue region wavelength emission LED, and the infrared wavelength emission LED may be configured in the form of a surface mount device (SMD) chip, or also configured in the form of forming a single LED module having a plurality of chips with a band shape. In addition, each LED may also be formed of a ball bulb type. That is, the blue region wavelength emission LED 130A, the red region wavelength emission LED 130B, and the infrared region wavelength emission LED 130C according to the present exemplary embodiment may be an LED package or an LED unit including a single LED element or a plurality of LED elements.

As an example, the blue region wavelength emission LED is configured to emit a wavelength having the maximum value at 450 nm, and the red region wavelength emission LED is configured to emit a wavelength having the maximum value at 660 nm. As the experiment result, the red LED with a wavelength of 660 nm maximizes the photosynthesis promotion of plants and has an important effect on a germination operation, and the blue LED with a wavelength of 450 nm has an important effect in the development process of forming chloroplast. It is known that the wavelengths of green and yellow do not help the growth of plants and are reflected or have a slight absorption rate.

As an example, the blue region wavelength emission LED and the red region wavelength emission LED may be implemented using a blue LED and a red LED, respectively.

FIG. 5 is a schematic diagram illustrating a light emitting unit according to another exemplary embodiment of the present disclosure.

In the present disclosure according to another exemplary embodiment, the light emitting unit 120 includes two or more first light emitting parts 122a, 122b, 122c, and a red region wavelength emission LED and a blue region wavelength emission LED of each of the first light emitting parts 122a, 122b, 122c are formed by applying different amounts of red fluorescent substances to one blue region wavelength emission LED, respectively.

As an example, the blue region wavelength emission LED 130A may be implemented by a blue LED or applying a small amount of red light emitting fluorescent substance to the blue LED, and the red region wavelength emission LED 130B may be implemented by applying a predetermined amount or more of red light emitting fluorescent substance to the blue LED.

That is, an amount of the red light emitting fluorescent substance applied to the blue region wavelength emission LED 130A and the red region wavelength emission LED 130B included in the first light emitting part 122a, which is any one of the first light emitting parts 122a, 122b, 122c, may be formed differently from an amount of the red light emitting fluorescent substance applied to the blue region wavelength emission LED 130A and the red region wavelength emission LED 130B included in the other first light emitting part 122b, 122c.

The fluorescent substance is a material which serves to absorb the light emitted from the LED and emit light having a different wavelength.

As an example, if a red fluorescent substance is applied to a blue LED, the light having the blue region wavelength emitted from the blue LED and the light having the red region wavelength emitted by a fluorescent material excited by the aforementioned light may be combined to form a blue light having a different wavelength or another color (for example, white, red, or the like) light.

The fluorescent substance is an inorganic compound consisting of an inorganic receptor material doped with an optically activated element, and consists of powder particles having the size of 1 to several tens of microns.

The red fluorescent substance according to the exemplary embodiment of the present disclosure may be formed of any one of several known red light emitting fluorescent substances, and as an example, may be an inorganic-based fluorescent substance such as K2SiF6:Mn4+, M2Si5N8 (M=Ca, Sr, Ba), (Ca, Sr)AlSiN3:Eu2+, or the like synthesized using SiO₂, KMnO₄, HF, and H₂O₂ compounds. At this time, the blue region wavelength emission LED to which the red fluorescent substance is applied may be a known blue light LED, or for example, a GaN LED emitting blue light.

The blue region wavelength emission LED and the red region wavelength emission LED having different wavelengths may be formed by applying different amounts of red fluorescent substances to the blue region wavelength emission LED, respectively, and an optimal optical spectrum suitable for the timing in each seedling raising stage may be provided by emitting the LED having various wavelengths by the PWM driving.

The fluorescent substance may be applied in the most widely used slurry method, a conformal method for uniformly applying the fluorescent substance to all surfaces of the LED, a remote method, or the like.

As another example, the blue region wavelength emission LED or the red region wavelength emission LED may be formed by applying a blue fluorescent substance or a red fluorescent substance to an UV LED for emitting near ultraviolet wavelengths (for example, 320 to 390 nm) or applying a blue fluorescent substance, a red fluorescent substance, and a green fluorescent substance in combination at different rates.

Meanwhile, a plurality of second light emitting parts 124a, 124b, 124c are formed like the first light emitting parts 122a, 122b, 122c, and red region wavelength emission LEDs 130B′ included in the second light emitting parts 124a, 124b, 124c are formed independently of the red region wavelength emission LEDs 130B included in the first light emitting parts 122a, 122b, 122c. In addition, the amounts of fluorescent substances applied to the red region wavelength emission LED 130B′ included in the second light emitting parts 124a, 124b, 124c may be the same as each other.

The LED lighting apparatus 100 for strawberry seedling raising according to the exemplary embodiment of the present disclosure further includes a camera module 160 for photographing the state of the strawberry seedling raising to collect an image, as illustrated in FIGS. 1 and 2.

The control part 140 controls the first light emitting part 122 or the second light emitting part 124 based on the state image of the strawberry seedling raising collected by the camera module 160.

As an example, the camera module 160 photographs a growth state around the runner of the strawberry seedling raising to collect an image.

The control part 140 may analyze the image collected from the camera module 160 to determine the growth state of the strawberry seedling raising, and control the first light emitting part 122 and the second light emitting part 124 to be turned on/off to emit the light having an appropriate wavelength, thereby increasing the production of the runner.

As another example, if the camera module 160 photographs the growth (growth) state around the flower bud portion of the strawberry seedling to collect an image, the control part 140 analyzes the collected image to determine the degree of the flower bud differentiation, and control the second light emitting part 124 to be turned on/off, thereby increasing the flower bud differentiation induction rate.

The image obtained by photographing the state of the strawberry seedling raising in the camera module 160 may be automatically collected for each predetermined cycle (for example, every hour), and the strawberry seedling raising manager may also set an image collection time.

As another example, the camera module 160 photographs whether a disease or a pest invades mainly the leaves of the strawberry seedling raising to collect an image.

The control part 140 analyzes the pre-stored state images of the strawberry seedling raising and the collected images of the leaves to determine whether a disease or a pest occurs, and for example, if it is determined that the pest has invaded, the control part 140 turns on the red region wavelength emission LED and the infrared region wavelength emission LED included in the second light emitting part 124, thereby avoiding disease and insect pest.

Generally, the pest prefers the light in the wavelength band of 400 to 450 nm, and mainly has the characteristic of avoiding the light in the wavelength band of 580 to 650 nm.

By periodically emitting the light from the LED emitting the wavelength of the 590 nm region close to the yellow light and the LED emitting the wavelength of the 630 nm region close to the red light using such a characteristic, it is possible to prevent the pest from approaching. The emission of each wavelength may be implemented through the LED formed by appropriately applying the aforementioned red fluorescent substance.

As another example, a separate LED emitting a wavelength of a corresponding region is provided on the outside of each light emitting unit 120 in order to combat the pest, and may also be configured to emit the light in the corresponding wavelength to the outside of the irradiation region of each LED emitted from the light emitting unit 120. The wavelength emission of the region avoided by the pest by the separate LED prefers the blue region wavelength of the first light emitting part 122 emitted to assist the growth in the seedling raising stage, thereby blocking the access of the pest trying to access the strawberry seedling raising in advance.

As illustrated in FIGS. 1 and 2, the LED lighting device 100 for strawberry seedling raising according to the exemplary embodiment of the present disclosure further includes a wavelength detection sensor 170 for detecting a wavelength of the light emitted from the light emitting unit 120.

The control part 140 corrects the state image of the seedling raising collected by the camera module 160 according to the wavelength of the light detected by the wavelength detection sensor 170.

Since the light emitting unit 120 according to each exemplary embodiment of the present disclosure emits a wavelength having a specific color rather than white light to the strawberry seedling raising, the image photographed and collected by the camera module 160 does not show the accurate state of the strawberry seedling raising.

Therefore, when the state image of the seedling raising collected by the camera module 160 is corrected according to the wavelength of the light detected by the wavelength detection sensor 170, it is possible to accurately confirm the actual state of the strawberry seedling raising through the corrected image, and to appropriately control the light emitting unit 120 according to the state of the strawberry seedling raising.

The LED lighting device 100 for strawberry seedling raising according to the exemplary embodiment of the present disclosure further includes a temperature sensor 180 for measuring the temperature of a strawberry seedling raising cultivation space, as illustrated in FIGS. 1 and 2.

The control part 140 controls the first light emitting part 122 or the second light emitting part 124 based on the temperature measured by the temperature sensor 180.

The flower bud differentiation of the strawberry is performed by the interaction of the temperature and the day length, and particularly, the flower bud differentiation is performed in a temperature range of 10 to 25 degrees Celsius and in the day length equal to or less than 12 hours.

The temperature range of 5 to 10 degrees Celsius or 25 to 30 degrees Celsius is not effective in the flower bud differentiation, and in the high temperature of 30 degrees or more Celsius, the flower bud differentiation is inhibited, so that it is necessary to appropriately adjust the temperature. Particularly, shading treatment is preferable during summer daytime when the strawberry seedling is exposed to the outside.

Therefore, it is preferable to control the driving of the second light emitting part 124 according to the exemplary embodiment of the present disclosure in conjunction with the internal temperature, and the second light emitting part 124 is configured to adjust a light irradiation time within the temperature of 25 degrees Celsius.

In the case of increasing daylight without using the LED lighting device 100 according to the present exemplary embodiment for flower bud differentiation, there is a problem in that the internal temperature is rapidly increased, thereby rather inhibiting the flower bud differentiation, but in the case of using the second light emitting part 124 of the LED light device 100 for strawberry seedling raising according to the present exemplary embodiment, the internal temperature is not largely increased even if the light emitting time is accumulated, so that there is an advantage in that a separate facility for adjusting the temperature is not required.

Meanwhile, at a temperature of less than 10 degrees Celsius, the first light emitting part 122 and the second light emitting part 124 may be simultaneously operated, thereby increasing the internal temperature.

Since the sensing by the camera module 160, the wavelength detection sensor 170, and the temperature sensor 180 and the control of the first light emitting part 122 and the second light emitting part 124 according to the state of the strawberry seedling raising by the control part 140 may be automatically performed, the accurate and stable strawberry seedling raising process is implemented by putting the minimal labor.

FIG. 6 is a schematic diagram illustrating an LED lighting device for strawberry seedling raising according to another exemplary embodiment of the present disclosure.

As illustrated in FIG. 6, another exemplary embodiment of the present disclosure further includes a condensing lens 190 for allowing the wavelengths (light) emitted from the first light emitting part 122 and the second light emitting part 124 to reach only within the strawberry seedling raising cultivation range at the end of the emission side of the light emitting unit 120.

The condensing lens 190 may be changed in shape according to the shape of a strawberry seedling raising bed, and for example, configured to fit the rectangular shape which is a general shape of the strawberry seedling raising bed to control the light emitted from the first light emitting part 122 and the second light emitting part 124 to be emitted into only the seedling raising bed.

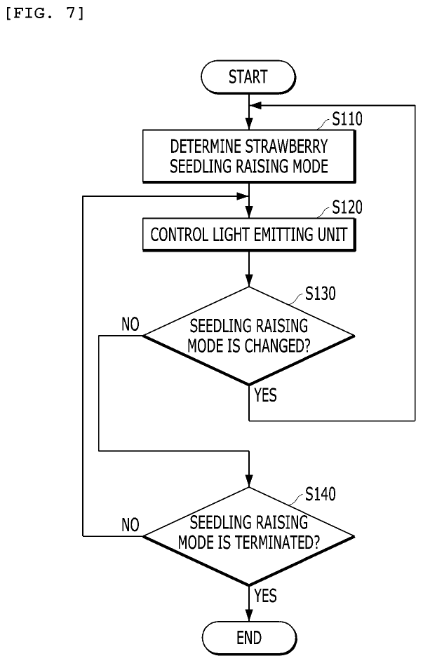

FIG. 7 is a flowchart illustrating a strawberry seedling raising method using the LED lighting device for strawberry raising seedling according to the exemplary embodiment of the present disclosure.

Referring to FIG. 7, the strawberry raising seedling method using the LED lighting device for strawberry raising seedling according to the exemplary embodiment of the present disclosure includes determining a strawberry raising seedling mode (S110) in which the preset seedling raising mode determines any one of a runner increase mode which increases the runners of the mother plants and a flower bud differentiation mode which induces flower bud differentiation of daughter seedlings, controlling a light emitting unit (S120) which controls at least one of the first light emitting part 122 and the second light emitting part 124 according to the determined strawberry seedling raising mode, determining whether the seedling raising mode has been changed (S130) which determines whether the strawberry seedling raising mode has been changed, and determining whether the seedling raising mode has been terminated (S140) which determines whether the strawberry seedling raising mode has been terminated. When it is determined that the strawberry raising seedling mode has been changed (S130), the control part 140 determines the changed strawberry raising seedling mode (S110) to control at least one of the first light emitting part 122 and the second light emitting part 124 according to the changed strawberry raising seedling mode (S120). In addition, when it is determined that the strawberry seedling raising mode has been terminated (S140), the control part 140 terminates a control.

More specifically, in the controlling of the light emitting unit (S120), the control part 140 controls all LEDs of the first light emitting part 122 and the second light emitting part 124 to be simultaneously turned on/off in the runner increase mode, and controls all LEDs of the second light emitting part 124 to be simultaneously turned on/off in the flower bud differentiation mode. At this time, the first light emitting part 122 and the second light emitting part 124 share the red region wavelength emission LED 130B, and in the runner increase mode, the output of the first light emitting part 122 is formed larger than the output of the second light emitting part 124, and the red region wavelength emission LED shared by the first light emitting part 122 and the second light emitting part 124 is controlled by the output of the first light emitting part 122. In addition, the output of the second light emitting part 124 in the flower bud differentiation mode is formed larger than the output of the second light emitting part 124 in the runner increase mode, and in the flower bud differentiation mode, (1) the output of the first light emitting part 122 and the output of the second light emitting part 124 are formed to be the same as each other, or (2) the output of the first light emitting part 122 is formed smaller than the output of the second light emitting part 124, and if the output of the first light emitting part 122 is formed smaller than the output of the second light emitting part 124, the red region wavelength emission LED shared by the first light emitting part 122 and the second light emitting part 124 is controlled by the output of the first light emitting part 122.

Meanwhile, in another exemplary embodiment, the LED lighting device for strawberry seedling raising includes a camera module for photographing the state of the strawberry seedling raising to collect an image and the LED lighting device for strawberry seedling raising further includes a wavelength detection sensor for detecting a wavelength of the light emitted from the light emitting unit. In addition, the control part 140 corrects the state image of the seedling raising collected by the camera module according to the wavelength of the light detected by the wavelength detection sensor, and the control part 140 controls the first light emitting part 122 or the second light emitting part 124 based on the corrected state image of the strawberry seedling raising collected by the camera module.

In addition, in still another exemplary embodiment, the LED lighting device for strawberry seedling raising further includes a temperature sensor for measuring the temperature of the strawberry seedling raising cultivation space, and the control part 140 controls the first light emitting part 122 or the second light emitting part 124 based on the temperature measured by the temperature sensor. At this time, in the flower bud differentiation mode which induces the flower bud differentiation of daughter seedlings, (1) if the temperature of the strawberry seedling raising cultivation space falls within a range of 10 degrees Celsius to 25 degrees Celsius, the control part operates only the second light emitting part 124 to suppress an increase in the temperature, and (2) if the temperature of the strawberry seedling raising cultivation space is less than 10 degrees Celsius, the control part operates the first light emitting part 122 and the second light emitting part 124 to increase the temperature. Meanwhile, operation times of the first light emitting part 122 and the second light emitting part 124 in the flower bud differentiation mode are formed to be equal to or less than 12 hours per day.

While the present disclosure has been described above in detail with reference to specific exemplary embodiments, the exemplary embodiments are merely examples for facilitating the understanding of the present disclosure, so that it should be noted that the substitutions, additions, and modifications of the present disclosure also fall within the scope of the present disclosure defined by the appended claims without departing from the technical sprit of the present disclosure.

Forms for carrying out the disclosure have been described together in the best mode for carrying out the foregoing disclosure.

### INDUSTRIAL APPLICABILITY

The present disclosure relates to a LED lighting device for strawberry seedling raising, and has repeatability and industrial applicability in a LED lighting device in which contents are accommodated or the like.

1. An LED lighting device for strawberry seedling raising comprising:
a light emitting unit comprising a first light emitting part comprising a red region wavelength emission LED and a blue region wavelength emission LED and a second light emitting part comprising the red region wavelength emission LED and an infrared region wavelength emission LED; and
a control part for controlling the light emitting unit to manage a strawberry seedling raising, and controlling each LED comprised in the first light emitting part or the second light emitting part to be turned on/off based on a preset seedling raising mode.

2. The LED lighting device for strawberry seedling raising of claim 1,
wherein the preset seedling raising mode is performed by any one of a runner increase mode which increases runners of mother plants or a flower bud differentiation mode which induces a flower bud differentiation of daughter seedlings,
wherein all LEDs of the first light emitting part and the second light emitting part are controlled to be turned on/off simultaneously in the runner increase mode, and
wherein all LEDs of the second light emitting part are controlled to be turned on/off simultaneously in the flower bud differentiation mode.

3. The LED lighting device for strawberry seedling raising of claim 2,
wherein the LEDs of the first light emitting part and the LEDs of the second light emitting part are controlled independently of each other, and controlled according to a state image and the number of runners of the strawberry seedling raising.

4. The LED lighting device for strawberry seedling raising of claim 1,
wherein the first light emitting part or the second light emitting part is controlled in a pulse width modulation (PWM) method.

5. The LED lighting device for strawberry seedling raising of claim 4,
wherein the first light emitting part and the second light emitting part share the red region wavelength emission LED,
wherein in the runner increase mode which increases the runners of the mother plants, an output of the first light emitting part is formed larger than an output of the second light emitting part, and the red region wavelength emission LED shared by the first light emitting part and the second light emitting part is controlled by the output of the first light emitting part, and
wherein the output of the second light emitting part in the flower bud differentiation mode which induces the flower bud differentiation of the daughter seedlings is formed larger than the output of the second light emitting part in the runner increase mode.

6. The LED lighting device for strawberry seedling raising of claim 5,
wherein in the flower bud differentiation mode, (1) the output of the first light emitting part and the output of the second light emitting part are formed to be the same as each other, or (2) the output of the first light emitting part is formed smaller than the output of the second light emitting part, and
wherein if the output of the first light emitting part is formed smaller than the output of the second light emitting part, the red region wavelength emission LED shared by the first light emitting part and the second light emitting part is controlled by the output of the first light emitting part.

7. The LED lighting device for strawberry seedling raising of claim 1,
wherein the light emitting unit comprises: two or more first light emitting parts, and
wherein the red region wavelength emission LED and the blue region wavelength emission LED of each of the first light emitting parts are formed by applying each of different amounts of red fluorescent substances to a single blue region wavelength emission LED.

8. The LED lighting device for strawberry seedling raising of claim 7,
wherein an amount of the red fluorescent substance applied to any one of the plurality of blue region wavelength emission LEDs of the first light emitting part is different from an amount of the red fluorescent substance applied to another blue region wavelength emission LED, and
wherein an amount of the red fluorescent substance applied to any one of the plurality of red region wavelength emission LEDs of the first light emitting part is different from an amount of the red fluorescent substance applied to another red region wavelength emission LED.

9. The LED lighting device for strawberry seedling raising of claim 7,
wherein the light emitting unit comprises: two or more second light emitting parts,
wherein the red region wavelength emission LEDs comprised in the second light emitting parts are formed independently of the red region wavelength emission LED comprised in the first light emitting part,
wherein an amount of the red fluorescent substance applied to any one of the plurality of blue region wavelength emission LEDs of the first light emitting part is the same as an amount of the red fluorescent substance applied to another blue region wavelength emission LED, and
wherein an amount of the red fluorescent substance applied to any one of the plurality of red region wavelength emission LEDs of the first light emitting part is the same as an amount of the red fluorescent substance applied to another red region wavelength emission LED.

10. The LED lighting device for strawberry seedling raising of claim 1, further comprising: a camera module for photographing the state of the strawberry seedling raising to collect an image,
wherein the control part controls the first light emitting part or the second light emitting part based on the state image of the strawberry seedling raising collected by the camera module.

11. The LED lighting device for strawberry seedling raising of claim 10, further comprising: a wavelength detection sensor for detecting a wavelength of the light emitted from the light emitting unit,
wherein the control part corrects the state image of the seedling raising collected by the camera module according to the wavelength of the light detected by the wavelength detection sensor.

12. The LED lighting device for strawberry seedling raising of claim 1, further comprising: a temperature sensor for measuring a temperature of a strawberry seedling raising cultivation space,
wherein the control part controls the first light emitting part or the second light emitting part based on the temperature measured by the temperature sensor.

13. The LED lighting device for strawberry seedling raising of claim 12,
wherein in the flower bud differentiation mode which induces the flower bud differentiation of the daughter seedlings, (1) if the temperature of the strawberry seedling raising cultivation space falls within a range of 10 degrees Celsius to 25 degrees Celsius, the control part operates only the second light emitting part to suppress an increase in the temperature, and (2) if the temperature of the strawberry seedling raising cultivation space is less than 10 degrees Celsius, the control part operates the first light emitting part and the second light emitting part to increase the temperature, and
wherein operation times of the first light emitting part and the second light emitting part in the flower bud differentiation mode are equal to or less than 12 hours per day.

14. The LED lighting device for strawberry seedling raising of claim 1, further comprising: a condensing lens for reaching the light emitted from the first light emitting part and the second light emitting part only within a strawberry seedling raising cultivation range on the end of the emission side of the light emitting unit.

15. The LED lighting device for strawberry seedling raising of claim 14,
wherein the condensing lens is formed in a shape corresponding to the form of a strawberry seedling raising bed in which the strawberry seedling raising is performed.

16. A strawberry seedling raising method using an LED lighting device for strawberry seedling raising comprising: a light emitting unit comprising a first light emitting part comprising a red region wavelength emission LED and a blue region wavelength emission LED and a second light emitting part comprising the red region wavelength emission LED and an infrared region wavelength emission LED; and a control part for controlling the light emitting unit to manage a strawberry seedling raising, and controlling each LED comprised in the first light emitting part or the second light emitting part to be turned on/off based on a preset seedling raising mode, the method comprising:
determining a strawberry seedling raising mode which determines, as the present seedling raising mode, any one of a runner increase mode which increases runners of mother plants and a flower bud differentiation mode which induces a flower bud differentiation of daughter seedlings; and
controlling the light emitting unit which controls at least one of the first light emitting part and the second light emitting part according to the determined strawberry seedling raising mode.

17. The method of claim 16,
wherein all LEDs of the first light emitting part and the second light emitting part are controlled to be turned on/off simultaneously in the runner increase mode, and
wherein all LEDs of the second light emitting part are controlled to be turned on/off simultaneously in the flower bud differentiation mode.

18. The method of claim 17,
wherein the first light emitting part and the second light emitting part share the red region wavelength emission LED,
wherein in the runner increase mode, an output of the first light emitting part is formed larger than an output of the second light emitting part, and the red region wavelength emission LED shared by the first light emitting part and the second light emitting part is controlled by the output of the first light emitting part,
wherein the output of the second light emitting part in the flower bud differentiation mode is formed larger than the output of the second light emitting part in the runner increase mode,
wherein in the flower bud differentiation mode, (1) the output of the first light emitting part and the output of the second light emitting part are formed to be the same as each other, or (2) the output of the first light emitting part is formed smaller than the output of the second light emitting part, and
wherein if the output of the first light emitting part is formed smaller than the output of the second light emitting part, the red region wavelength emission LED shared by the first light emitting part and the second light emitting part is controlled by the output of the first light emitting part.

19. The method of claim 17,
wherein the LED lighting device for strawberry seedling raising comprises: a camera module for photographing a state of the strawberry seedling raising to collect an image; and the LED lighting device for strawberry seedling raising further comprises: a wavelength detection sensor for detecting a wavelength of the light emitted from the light emitting unit,
wherein the control part corrects a state image of the seedling raising collected by the camera module according to the wavelength of the light detected by the wavelength detection sensor, and
wherein the control part controls the first light emitting part or the second light emitting part based on the corrected state image of the strawberry seedling raising collected by the camera module.

20. The method of claim 17,
wherein the LED lighting device for strawberry seedling raising further comprises: a temperature sensor for measuring the temperature of a strawberry seedling raising cultivation space,
wherein the control part controls the first light emitting part or the second light emitting part based on the temperature measured by the temperature sensor,
wherein in the flower bud differentiation mode which induces the flower bud differentiation of the daughter seedlings, (1) if the temperature of the strawberry seedling raising cultivation space falls within a range of 10 degrees Celsius to 25 degrees Celsius, the control part operates only the second light emitting part to suppress an increase in the temperature, and (2) if the temperature of the strawberry seedling raising cultivation space is less than 10 degrees Celsius, the control part operates the first light emitting part and the second light emitting part to increase the temperature, and
wherein operation times of the first light emitting part and the second light emitting part in the flower bud differentiation mode are equal to or less than 12 hours per day.
